(19) United States
(12) Patent Application Publication
(10) Pub. No.: US 2026/0288176 A1
(43) Pub. Date: Sep. 24, 2026

(54) SYSTEM AND METHOD FOR MONITORING AND CONTROLLING AUTONOMOUS SYSTEM OPERATIONS

(71) Applicant: THE BOEING COMPANY, Arlington, VA (US)

(72) Inventors: Brendan Patrick Williams, Brisbane (AU); Reece Alexander Clothier, Brisbane (AU)

(21) Appl. No.: 19/088,398

(22) Filed: Mar. 24, 2025

(51) Int. Cl. G05D 1/82; G05D 101/10; G05D 109/20

(52) U.S. Cl. CPC G05D 1/82; G05D 2101/10; G05D 2109/20

(57) ABSTRACT

A method of operating an autonomous control system within a device includes receiving command and intent data related to a proposed operation of a device. The method also includes determining an operational context based on sensor data and the proposed operation, and performing a comparison based on the operational context and the command and intent data. generating an output signal based on the comparison. The method further includes controlling the proposed operation of the device based on the generated output signal.

### FIELD OF THE DISCLOSURE

The present disclosure is generally related to autonomous control systems, and more particularly to systems and methods for monitoring and controlling autonomous system operations based on operational intent and environmental context.

### BACKGROUND

As autonomous systems become increasingly prevalent across military, commercial, and civil applications, ensuring safe and appropriate operation of the autonomous systems has become increasingly complex. Traditional autonomous systems primarily rely on safety monitors that focus on basic operational parameters, such as speed, position, and system limitations. However, these conventional approaches do not address the broader considerations of operational appropriateness, risk assessment, and contextual decision-making that are critical when autonomous systems operate in dynamic, real-world environments.

Current safety monitoring systems typically implement pre-defined operational constraints and safety parameters. While effective for maintaining basic system safety, these systems are not designed to evaluate the appropriateness of autonomous actions within a broader operational context. For example, a conventional safety monitor may confirm that an autonomous vehicle can safely execute a maneuver within its physical capabilities, but does not evaluate whether that maneuver is appropriate given the current environmental conditions or operational context. Additionally, existing approaches often require manual intervention or pre-programmed responses when facing complex operational scenarios. This can result in either overly conservative operational restrictions or potential gaps in safety coverage when encountering novel situations. The challenge is further complicated when multiple contextual factors must be considered simultaneously, such as environmental conditions, operational objectives, and risk tolerances.

Existing solutions also struggle to provide a clear audit trail of decision-making processes and operational authorizations. This lack of traceability makes it difficult to validate system behavior and ensure accountability, particularly in applications where autonomous decisions can have significant consequences.

### SUMMARY

According to one implementation of the present disclosure, a method of operating an autonomous control system within a device is disclosed. The method includes receiving command and intent data related to a proposed operation of a device. The method includes determining an operational context based on sensor data and the proposed operation. The method further includes performing a comparison based on the operational context and the command and intent data. The method also includes generating an output signal based on the comparison, and controlling the proposed operation of the device based on the generated output signal.

According to another implementation of the present disclosure, a device includes one or more processors configured to receive command and intent data related to a proposed operation of the device. The one or more processors are further configured to determine an operational context based on sensor data and the proposed operation, and perform a comparison based on the operational context and the command and intent data. The one or more processors are also configured to generate an output signal based on the comparison, and control the proposed operation of the device based on the generated output signal.

According to another implementation of the present disclosure, a non-transitory computer-readable medium including instructions that, when executed by one or more processors, cause the one or more processors to receive command and intent data related to a proposed operation of a device, and determine an operational context based on sensor data and the proposed operation. The instructions further cause the one or more processors to perform a comparison based on the operational context and the command and intent data, and generate an output signal based on the comparison. The instructions also cause the one or more processors to control the proposed operation of the device based on the generated output signal.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system configured to monitor and control an operation based on operational intent and environmental context.

FIG. 2 is a flow diagram illustrating an example of operations performed by a device, as in FIG. 1, to aid in monitoring and controlling an operation based on operational intent and environmental context.

FIG. 3 is a flow chart of a method of monitoring and controlling an operation based on operational intent and environmental context.

FIG. 4 is a flowchart illustrating an example of a life cycle of an aircraft that includes a device of FIG. 1.

FIG. 5 is a block diagram illustrating aspects of an illustrative aircraft that includes a device of FIG. 1.

FIG. 6 is a diagram of electronic components of a system for monitoring and controlling an operation based on operational intent and environmental context.

### DETAILED DESCRIPTION

As autonomous systems become increasingly sophisticated, inefficiencies related to operational safety and system effectiveness due to traditional approaches for monitoring autonomous operations have become more pronounced. Such inefficiencies can be reduced or minimized by integrated approaches to manage autonomous system operations based on operational intent and environmental context. Such approaches should be capable of automatically evaluating proposed actions while accounting for variations in operational conditions and system configuration throughout operation of the system.

The disclosed system presents a new approach to monitoring and controlling autonomous systems by introducing an operational intent monitor that evaluates system actions based on both traditional safety parameters and broader operational context. Instead of simply checking whether an action is physically possible or safe, the system ensures that actions align with operational intent, risk tolerances, and environmental conditions. The operational intent monitor functions as a sophisticated supervisory control system for autonomous operations. Rather than relying solely on predefined safety parameters, this system evaluates multiple contextual factors when assessing autonomous decisions. For example, when an autonomous vehicle needs to make a landing decision, the system evaluates not just physical landing parameters but also environmental factors, current risk tolerance levels, and alignment with overall system/mission objectives.

The system operates by receiving command and intent data that define operational parameters and constraints. These instructions originate from authorized sources and conform to a predefined grammatical structure that enables precise interpretation. During autonomous system operation, the operational intent monitor continuously acquires environmental data through various sensors including visual, audio, radio frequency, and atmospheric sensing systems. Based on a proposed action by the autonomous system, the operational intent monitor performs a comprehensive evaluation to determine whether the action should proceed. This evaluation compares the proposed action against both the command and intent data and the current operational context. Based on this comparison (e.g., assessment), the monitor generates control signals to enable or disable the proposed action, or in certain scenarios, may override standard operational parameters to achieve improved safety outcomes.

The system may implement audit trail functionality to maintain detailed records of all operational decisions, including the command and intent data, environmental conditions, and reasoning that led to each control decision. This provides a verifiable record of autonomous system behavior for subsequent analysis and validation.

The system demonstrates particular utility in complex operational scenarios where traditional safety monitoring systems may be insufficient. For example, during emergency operations, the system can authorize actions that might exceed normal operational constraints if the operational context justifies such decisions. Conversely, it may prevent actions that satisfy basic safety requirements but are inappropriate given current environmental conditions or operational intent.

By using the techniques and systems described herein, the systems and methods described herein provide an improved approach for monitoring and controlling autonomous system operations would enhance operational safety, increase system effectiveness, and provide better accountability for autonomous decision-making. For example, organizations can achieve more precise and efficient autonomous operations while maintaining high levels of operational safety. The automated evaluation system can process complex operational scenarios in real-time, eliminating the need for time-consuming manual oversight. The system provides more precise operational control by continuously updating its contextual assessment based on current environmental conditions, unlike traditional safety monitors that rely on predefined parameters. The system reduces operational complexity through automated intent verification rather than requiring manual validation procedures. The system also enables improved scalability of autonomous operations by providing a standardized framework for intent-based control that can be applied across different platforms and operational scenarios. These technical advantages enhance autonomous system reliability, reduce operational overhead, improve decision-making transparency, and enable more sophisticated autonomous operations while ensuring appropriate operational behavior throughout operation (e.g., throughout a mission).

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

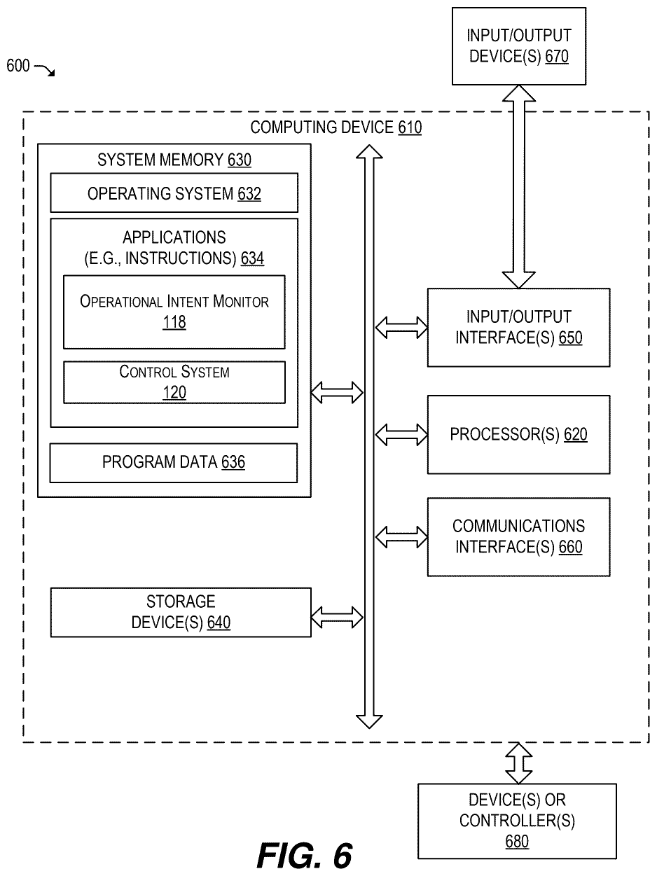

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 6 depicts a computing device 610 including one or more processors (“processor(s)” 620 in FIG. 6), which indicates that in some implementations the computing device 610 includes a single processor 620 and in other implementations the computing device 610 includes multiple processors 620. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

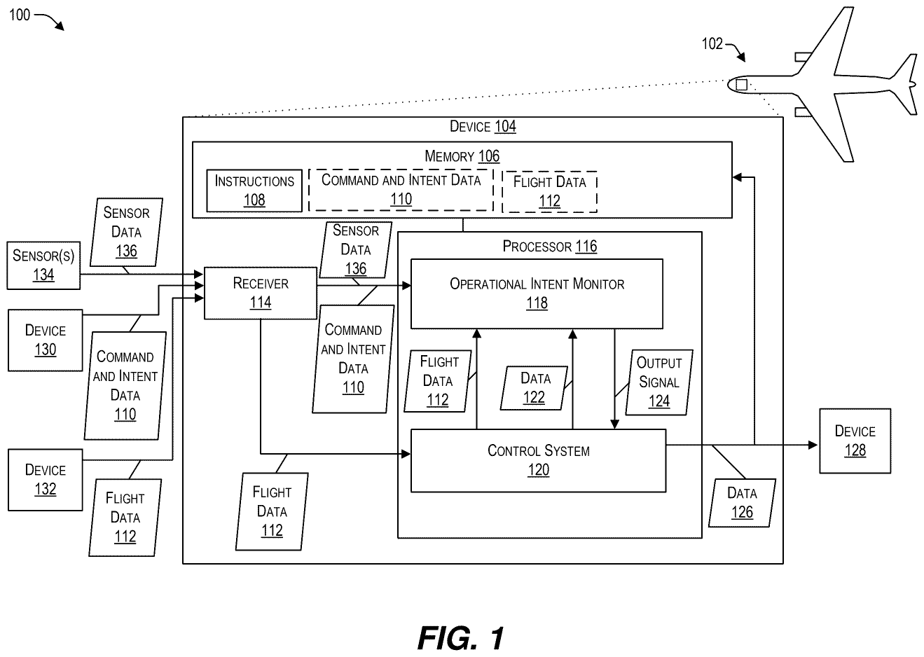

FIG. 1 is a diagram that illustrates a system 100 configured to monitor and control an operation based on operational intent and environmental context. The system 100 includes an aircraft 102 having a device 104 configured to monitor and control autonomous operations based on operational intent and environmental context. While FIG. 1 depicts an aircraft 102, it should be understood that the system 100 can be implemented in various vehicles including unmanned aerial vehicles, autonomous automobiles, autonomous marine vessels, autonomous robots, autonomous submarines, and other autonomous or semi-autonomous vehicles or systems.

The device 104 includes a memory 106 coupled to a processor 116. The memory 106 is configured to store instructions 108 and several categories of data. The processor 116 includes an operational intent monitor 118 and a control system 120. A receiver 114 is configured to receive sensor data 136 from one or more sensors 134. The sensors 134 are configured to detect various environmental conditions and may include audio sensors for detecting sound patterns (e.g., human voices, vehicle sounds, or emergency sirens), radio frequency sensors for monitoring communication patterns, visual sensors (e.g., cameras or LIDAR) for identifying objects or persons, and atmospheric sensors for measuring environmental conditions (e.g., temperature, pressure, or air quality).

The control system 120 may, by way of non-limiting examples, include one or more functions or systems associated with motion control (e.g., flight control), vehicle management and control, contingency management and control, mission management and control, actuation management and control, behavior management and control, or a combination thereof. In some implementations, the control system 120 may include one or more functions or systems associated with motion control (e.g., flight control), vehicle management and control, contingency management and control, mission management and control, actuation management and control, and behavior management and control.

In some implementations, the command and intent data 110 and flight data 112 are received from device 130 and device 132, respectively. The proposed operation contained within the command and intent data 110 may originate from either a user input interface or the control system 120. For example, device 130 is configured to generate, via a user input interface, the command and intent data 110 including proposed operations. In some aspects, device 130 may provide the command and intent data 110 containing a proposed operation to modify cargo delivery routes based on local noise ordinances. Device 130 may include a ground-based computer, smartphone, tablet, or other user devices located separately from device 104. Additionally, device 132 is configured to generate the flight data 112, and may include a ground-based computer or other user devices.

The command and intent data 110 includes multiple components designed to ensure safe and ethical operation of the aircraft 102. Rule sets define authorized operations, such as “Cargo delivery operations must maintain 1000 ft minimum altitude over residential areas between 10 PM and 7 AM.” Environmental parameters specify conditions for each rule set, such as “Wind speed less than 25 knots for rooftop landing operations.” The operational intent monitor 118 is configured to implement rule prioritization through combinatorial logic that defines how rules interact and cascade. For example, noise abatement rules may be overridden by emergency protocols, which in turn may be overridden by imminent safety concerns. The operational intent monitor 118 may resolve conflicts through priority designations-emergency landing protocols take precedence over noise abatement rules, which take precedence over efficiency optimizations. In scenarios with competing priorities, the operational intent monitor 118 is configured to evaluate the total risk profile across multiple dimensions including safety, environmental impact, and mission objectives. For example, when evaluating an emergency landing scenario, the operational intent monitor 118 might determine that exceeding noise restrictions is acceptable to reach a safer landing zone but would not authorize exceeding aircraft structural limits even in emergency conditions.

To ensure the integrity and proper interpretation of the command and intent data 110, the device 104 implements a predefined grammatical structure with one or more types of rules. For example, the one or more types of rules can include syntax rules that specify formats for operational constraints, such as “SPEED_LIMIT [value] [units] IN [zone_type]”, semantic rules that define relationships between constraints, such as “Landing zone size requirements scale with wind speed”, validation rules that evaluate constraint combinations, such as “Cannot simultaneously activate emergency power and noise abatement modes”, or a combination thereof.

The operational intent monitor 118 is configured to implement verification of the command and intent data 110. The operational intent monitor 118 determines whether the command and intent data 110 originated from authorized sources, with different authority levels having different operational permissions. For example, ground station operators may have authority to modify flight paths while maintenance personnel may have authority to modify operational limitations. The operational intent monitor 118 validates that the command and intent data 110 conforms to the predefined grammatical structure, ensuring commands like “SET_MAX_SPEED 150” follow required syntax.

The proposed operation may include various operational modifications. The proposed operation may involve modifying operational constraints of the control system 120, such as adjusting maximum speed limits in residential areas based on time of day. The proposed operation may also include evaluating potential outcomes based on the operational context, such as analyzing multiple landing site options given current weather conditions, visibility, and population density in various areas. Additionally, the proposed operation may implement modified operational parameters to achieve an improved overall safety outcome, such as exceeding standard descent rate limitations to reach a clear landing zone when the sensors 134 indicate severe mechanical issues.

The operational intent monitor 118 is configured to determine the operational context through a systematic multi-step process for evaluating proposed operations. The operational intent monitor 118 is configured to identify a set of environmental conditions from the sensor data 136. For example, visual sensors may detect obstacles or persons, audio sensors may identify vehicle traffic patterns, and atmospheric sensors may measure temperature, humidity, and wind conditions. The operational intent monitor 118 is further configured to determine relationships within these conditions, such as how wind speed and direction correlate with temperature gradients to indicate turbulence potential. The operational intent monitor is further configured to compare these relationship patterns to operational requirements specified in the command and intent data 110. For example, if the command and intent data 110 specifies maximum turbulence thresholds for cargo operations, the monitored relationship patterns are evaluated against these thresholds.

In some implementations, the receiver 114 receives the command and intent data 110 and the flight data 112 from the device 130 and the device 132, respectively. The command and intent data 110 includes one or more proposed operations with corresponding conditions. The operational intent monitor 118 is configured to process the received sensor data 136 to establish an operational context and evaluate each proposed operation from the command and intent data 110 against this operational context to determine whether the proposed operation should be enabled or disabled.

The operational intent monitor 118 processes remote commands while maintaining safety and ethical compliance. For example, the command and intent data 110 received from device 130 can include a proposed operation to modify the flight path to avoid forecasted turbulence when specific atmospheric conditions are detected. The operational intent monitor 118 processes the sensor data 136 from atmospheric sensors monitoring air pressure, wind speeds, and temperature gradients. When the sensor data 136 indicates conditions matching the criteria specified in the command and intent data 110, the operational intent monitor 118 generates an output signal 124 enabling the proposed path modification operation.

In some implementations, the command and intent data 110 and the flight data 112 are stored in the memory 106 of device 104, as illustrated by the dashed lines in FIG. 1. The flight data 112 includes critical operational parameters such as current altitude, airspeed, heading, system status indicators, navigation data, and environmental conditions that the operational intent monitor 118 may use to evaluate proposed operations. The control system 120 is configured to generate data 122 indicating a proposed operation and provide the data 122 to the operational intent monitor 118. The operational intent monitor 118 is configured to process the sensor data 136 and the command and intent data 110 to establish an operational context, and evaluate the proposed operation indicated by the data 122 against this operational context. Based on this evaluation and the flight data 112, the operational intent monitor 118 determines whether the proposed operation should be enabled or disabled.

In some implementations, the operational intent monitor 118 is configured to process situations requiring rapid response to changing conditions. For example, when the control system 120 generates a proposed operation to reduce altitude over a residential area during nighttime hours, the operational intent monitor 118 processes the sensor data 136 indicating populated areas below and time of day, along with the command and intent data 110 defining noise abatement requirements. The operational intent monitor 118 also considers the flight data 112, including current altitude, descent rate capabilities, and aircraft performance parameters, to determine if the proposed operation can be executed safely. Based on this comprehensive evaluation, the operational intent monitor 118 is configured to generate an output signal 124 enabling or disabling the proposed operation.

The operational intent monitor 118 is configured to balance multiple operational constraints. For example, the control system 120 generates a proposed operation to divert to an alternate landing site due to deteriorating weather conditions. The operational intent monitor 118 processes the sensor data 136 indicating severe turbulence along the current route along with the command and intent data 110 defining safety parameters. Based on this evaluation, the operational intent monitor 118 is configured to generate an output signal 124 enabling the proposed operation.

The control system 120 is configured to receive the output signal 124 that either enables or disables the proposed operation. Based on the output signal 124 and the flight data 112, the control system 120 is configured to generate data 126 for implementation of the enabled operation or modification of a disabled operation.

Device 128, which is located on the aircraft 102, is configured to execute the proposed operations when the output signal 124 indicates an enable signal. The data 126 is configured to be stored in either the memory 106 or a storage device located at a ground station for subsequent review and analysis. In some implementations, the data 126 includes audit trails, such as audit trails including timestamps, system states of the control system 120, sensor readings from sensors 134, detected environmental patterns, evaluation criteria applied by the operational intent monitor 118, and decision outcomes. For each operational decision, the data 126 may include the command and intent data 110, including any override conditions or priority modifications implemented by the operational intent monitor 118. The operational intent monitor 118 captures full environmental context through time-series sensor data 136, identified patterns, and relationship analyses derived from the sensor data 136. The data 126 can encompass both raw sensor data 136 and processed analytical results to facilitate comprehensive post-operation review. When the operational intent monitor 118 modifies or overrides safety parameters, the data 126 can include justification chains (e.g., analysis and/or decision data) demonstrating how the operational context necessitated the parameter modifications. This comprehensive data collection enables thorough post-operation analysis, including evaluation of decisions, validation of ethical guideline compliance, and refinement of operational parameters for future operations.

In some implementations, the operational intent monitor 118 processes scenarios involving system breakdowns. In an automated emergency landing scenario, the command and intent data 110 includes a proposed operation to land at a designated emergency landing site when certain system breakdowns are detected. The operational intent monitor 118 evaluates the sensor data 136 from multiple sources to verify the site's suitability. Visual sensors detect persons or obstacles in the landing zone, audio sensors identify human activity or vehicle sounds, and atmospheric sensors assess wind conditions and visibility. When the sensor data 136 indicates the presence of civilians in the proposed landing zone, the operational intent monitor 118 generates an output signal 124 disabling the proposed operation, causing evaluation of the next alternative landing site specified in the command and intent data 110.

In some implementations, the operational intent monitor 118 processes situations requiring safety parameter modifications. For example, the command and intent data 110 includes a proposed operation to exceed standard rate-of-descent parameters when specific emergency conditions are met. The operational intent monitor 118 processes the sensor data 136 showing a densely populated area ahead versus a clear area requiring the aggressive descent. Based on the hierarchical safety priorities defined in the command and intent data 110, the operational intent monitor 118 generates an output signal 124 enabling the proposed operation to exceed normal safety parameters when the sensor data 136 confirms the conditions specified in the command and intent data 110 are met.

In some implementations, the operational intent monitor 118 is configured to override standard safety parameters when necessary to prevent more serious outcomes. For example, when the aircraft 102 experiences a critical system breakdown, the operational intent monitor 118 authorizes exceeding normal operational limits to reach a safer landing area. When the sensors 134 detect a populated area directly ahead and a less populated area that would require operating beyond standard safety margins to reach, the operational intent monitor 118 enables exceeding those margins to minimize risk.

In some implementations, the operational intent monitor 118 adapts operations during execution through continuous monitoring of updated sensor data 136. For example, during a rooftop delivery operation, the sensor data 136 indicates unexpected helicopter activity near the destination. The operational intent monitor 118 determines an updated context incorporating this new traffic information, reevaluates the proposed operation against safety requirements, and modifies the operation to hold at a safe distance until the area clears.

In some implementations, the operational intent monitor 118 employs comprehensive risk analysis during emergency scenarios through dynamic safety parameter modification. During emergency landing situations, the operational intent monitor 118 continuously evaluates multiple landing options by comparing both standard safety parameters and broader ethical considerations defined in the command and intent data 110. When the sensors 134 detect a densely populated area ahead versus a clear area requiring aggressive descent, the operational intent monitor 118 may authorize exceeding normal descent rate limitations specified in the command and intent data 110 to reach the clearer landing zone. The operational intent monitor 118 bases this override decision on comprehensive risk analysis, determining that the increased risk from exceeding normal flight parameters is outweighed by the reduced risk to civilian populations detected by the sensors 134.

In some implementations, the operational intent monitor 118 implements nuanced parameter modifications based on specific scenario characteristics identified through the sensor data 136. For instance, when the sensor data 136 indicates mechanical issues requiring immediate landing, the operational intent monitor 118 may determine that exceeding normal bank angle limitations defined in the command and intent data 110 is acceptable to reach a clear landing zone, while maintaining minimum separation requirements from buildings or crowds detected by the sensors 134. The operational intent monitor 118 bases these decisions on real-time sensor data 136 from multiple sources—e.g., visual sensors detecting clear areas, audio sensors identifying human activity patterns, and atmospheric sensors validating wind conditions. The operational intent monitor 118 ties each parameter modification to specific contextual triggers detected in the sensor data 136 and limits modifications in scope and duration to address immediate safety requirements while maintaining maximum possible compliance with standard operating parameters specified in the command and intent data 110.

In some implementations, the operational intent monitor 118 performs multi-factor analysis incorporating both physical and ethical constraints when evaluating potential landing sites. For example, when the sensors 134 detect a large open area that initially appears suitable based on physical parameters but then identify emergency vehicle activity or civilian gatherings through subsequent sensor data 136, the operational intent monitor 118 dynamically updates its assessment. The operational intent monitor 118 may determine that a technically more challenging landing approach to an alternative site specified in the command and intent data 110 is preferable to disrupting emergency operations or endangering civilians detected by the sensors 134. This implementation demonstrates how the operational intent monitor 118 balances technical safety parameters against broader ethical considerations defined in the command and intent data 110 during real-time decision-making operations.

By using the techniques and systems described herein, the operational intent monitor 118 provides significant technical advantages through its real-time validation capabilities. The operational intent monitor 118 enables comprehensive ethical and operational validation through continuous monitoring of environmental conditions and comparison against predefined constraints. This validation capability allows for dynamic adjustment of operations based on changing conditions while maintaining compliance with ethical and operational requirements. In some implementations, the operational intent monitor 118 implement a dedicated processing architecture, providing enhanced safety and reliability through specialized evaluation of ethical and operational constraints. The architectural design may ensure robust decision-making through independent assessment of operational parameters and validation functions.

The operational intent monitor 118 may process both stored command and intent data 110 and remotely provided command and intent data 110, enabling operational flexibility while maintaining security. This dual processing capability allows the operational intent monitor 118 to validate operations using stored parameters during communication limitations while also incorporating updated guidance from authorized remote sources as operational conditions change. Additionally, or alternatively, the operational intent monitor 118 can implement sophisticated risk management capabilities through dynamic analysis of operational scenarios. The system may enable nuanced decisions considering broader ethical implications and potential outcomes, particularly in emergency situations where multiple operational parameters must be evaluated to determine optimal responses. This analysis framework supports effective decision-making across complex operational scenarios.

In some aspects, the operational intent monitor 118 may evaluate proposed or “what-if” scenarios against the command and intent data 110. The operational intent monitor 118 may evaluate the ethical and operational suitability or compliance for those scenarios. This aspect demonstrates scenario evaluation (e.g., what if a landing was required now, or what if a diversion due to weather was required now) to inform potential operational options.

The operational intent monitor 118 can also maintain records (e.g., comprehensive records) of all decisions and supporting data, storing them both in the memory 106 and/or at ground stations for thorough post-operation analysis. This detailed data collection and retention enables systematic analysis of operational decisions while ensuring accountability for all autonomous operations. Additionally, or alternatively, the operational intent monitor 118 may employ a modular processing architecture that enables adaptation to different operational contexts and requirements through standardized interfaces. This modularity allows the operational intent monitor 118 to incorporate updated command and intent data 110 reflecting new operational parameters while maintaining consistent validation functions. The system 100 can thereby support dynamic operational requirements through this flexible architectural framework.

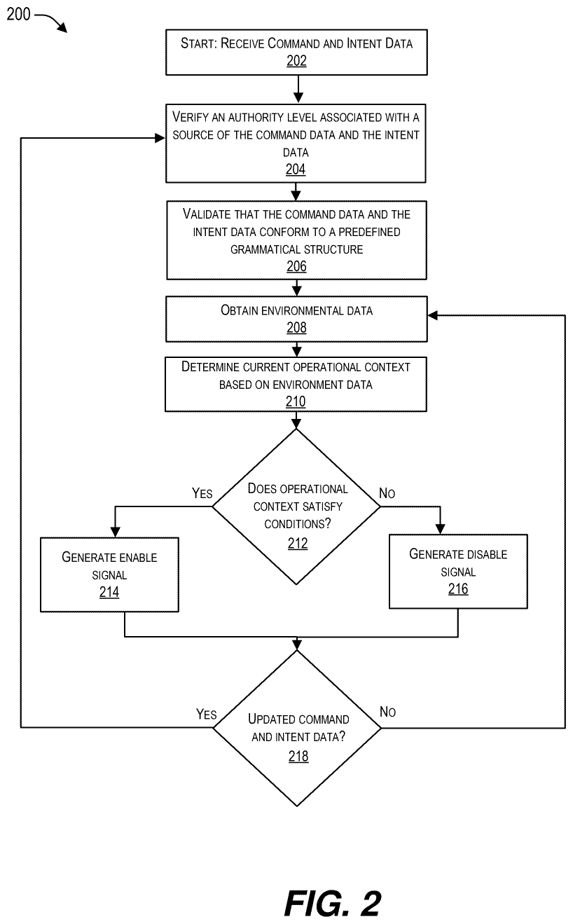

FIG. 2 is a flow diagram 200 illustrating operations performed by the device 104 to monitor and control operations based on operational intent and environmental context. The device 104 executes these operations through various components described in FIG. 1, including the memory 106, the processor 116, the operational intent monitor 118, and the control system 120.

At block 202, the process begins when the command and intent data 110 is received. The command and intent data 110 may be received from device 130 or accessed from the memory 106 as illustrated in FIG. 1. The command and intent data 110 includes one or more proposed operations with corresponding conditions.

At block 204, the operational intent monitor 118 verifies an authority level associated with a source of the command and intent data 110. Different authority levels correspond to different operational permissions. For example, ground station operators may have authority to modify flight paths while maintenance personnel may have authority to modify operational limitations.

At block 206, the operational intent monitor 118 validates that the command and intent data 110 conforms to a predefined grammatical structure. This structure includes syntax rules for specifying operational constraints, semantic rules defining relationships between constraints, validation rules for evaluating constraint combinations, or a combination thereof.

At block 208, the device 104 obtains environmental data (sensor data 136) through the receiver 114 from the sensors 134. The sensors 134 may include audio sensors detecting sound patterns, radio frequency sensors monitoring communication patterns, visual sensors identifying objects or persons, atmospheric sensors measuring environmental conditions, or a combination thereof.

At block 210, the operational intent monitor 118 determines the current operational context based on the environmental data. This determination involves identifying environmental conditions from the sensor data 136, determining relationships within these conditions, and comparing these relationship patterns to operational requirements specified in the command and intent data 110.

At block 212, the operational intent monitor 118 evaluates whether the operational context satisfies conditions specified in the command and intent data 110. This evaluation considers multiple factors including safety parameters, operational constraints, and ethical requirements defined in the command and intent data 110.

At block 214, if the operational context satisfies the conditions, the operational intent monitor 118 generates an enable signal as output signal 124. This enable signal authorizes the control system 120 to proceed with implementing the proposed operation.

At block 216, if the operational context does not satisfy the conditions, the operational intent monitor 118 generates a disable signal as output signal 124. This disable signal prevents the control system 120 from implementing the proposed operation.

At block 218, the operational intent monitor 118 checks for updated command and intent data 110. If updated command and intent data 110 is received, the process returns to block 204 to verify the authority level of the updated command and intent data 110. If no updated command and intent data 110 is received, the process returns to block 208 to continue monitoring environmental conditions. This continuous monitoring enables real-time adaptation to changing operational conditions while maintaining compliance with safety and ethical requirements.

The flow diagram 200 implements a systematic approach to validating and controlling operations based on both operational intent and environmental context. The continuous verification of authority levels, validation of command structure, and evaluation of environmental conditions ensures operations proceed only when appropriate conditions are met. This automated monitoring reduces operator burden while maintaining operational safety and ethical compliance across various phases of operation.

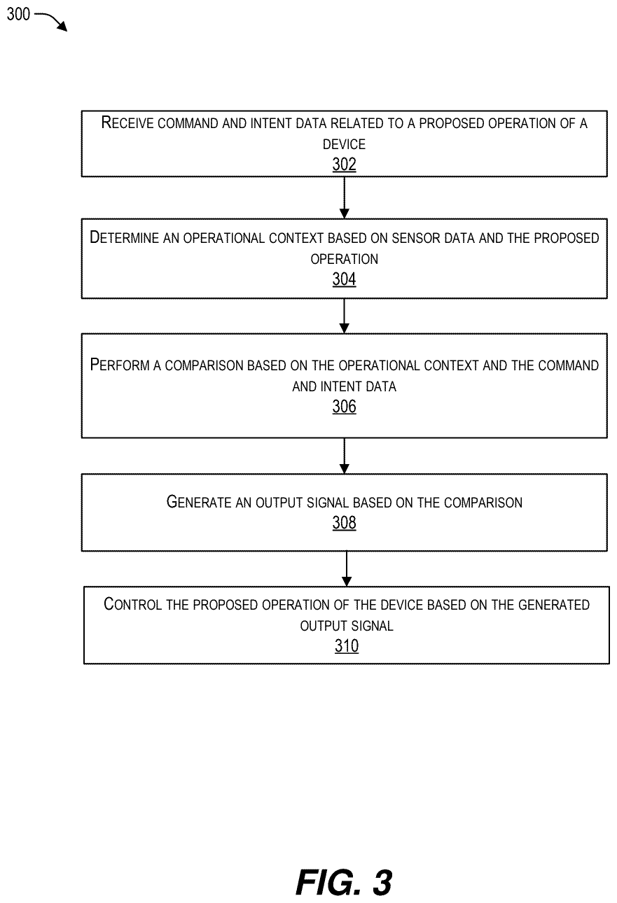

FIG. 3 illustrates a method 300 of monitoring and controlling operations of a device based on operational intent and environmental context. The method may be performed by the system 100, the device 104, the processor 116, the operational intent monitor 118, the control system 120, or a combination thereof.

The method 300 includes, at block 302, receiving command and intent data 110 related to a proposed operation of a device. For example, device 104 may receive command and intent data 110 from device 130 containing a proposed operation to modify cargo delivery routes based on local noise ordinances. The command and intent data 110 includes rule sets defining authorized operations, such as maintaining minimum altitude requirements over residential areas during specified hours, environmental parameters specifying conditions for each rule set, combinatorial logic defining how rules interact, priority designations for resolving conflicts between different operational requirements, or a combination thereof.

At block 304, the method 300 includes determining an operational context based on sensor data and the proposed operation. For example, the operational intent monitor 118 processes the sensor data 136 from multiple sources to establish the current operational context. The sensors 134 include visual sensors detecting obstacles or persons in the operational area, audio sensors identifying patterns of human activity or vehicle sounds, radio frequency sensors monitoring communication patterns, and atmospheric sensors measuring environmental conditions such as temperature, humidity, and wind conditions. The operational intent monitor 118 analyzes relationships within these conditions, such as how wind speed and direction correlate with temperature gradients to indicate turbulence potential.

At block 306, the method 300 includes performing a comparison based on the operational context and the command and intent data. For example, during a rooftop delivery operation, the operational intent monitor 118 compares the detected environmental conditions from the sensor data 136 against the operational requirements specified in the command and intent data 110. The operational intent monitor 118 evaluates whether current wind conditions meet specified thresholds for safe landing operations, assesses whether detected activity in the landing zone complies with safety parameters, and determines if the operation satisfies noise abatement requirements based on time of day and detected population density in the area.

At block 308, the method 300 includes generating an output signal based on the comparison. For example, when the operational context indicates severe turbulence along the current route that exceeds safety thresholds defined in the command and intent data 110, the operational intent monitor 118 generates output signal 124 as a disable signal preventing continuation along the planned route. Conversely, when the sensors 134 confirm that a proposed emergency landing zone is clear of obstacles and civilians, meeting the safety requirements specified in the command and intent data 110, the operational intent monitor 118 generates output signal 124 as an enable signal authorizing the landing operation.

At block 310, the method 300 includes controlling the proposed operation of the device based on the generated output signal. For example, when the operational intent monitor 118 generates output signal 124 as an enable signal authorizing a proposed path modification to avoid forecasted turbulence, the control system 120 implements the modified flight path while maintaining compliance with other operational constraints. When the operational intent monitor 118 generates output signal 124 as a disable signal due to detected civilian activity in a proposed emergency landing zone, the control system 120 prevents the landing operation and initiates evaluation of alternative landing sites specified in the command and intent data 110. The operational intent monitor 118 maintains continuous monitoring of environmental conditions during execution through sensor data 136, allowing for real-time adjustments to operations while ensuring compliance with safety and ethical requirements.

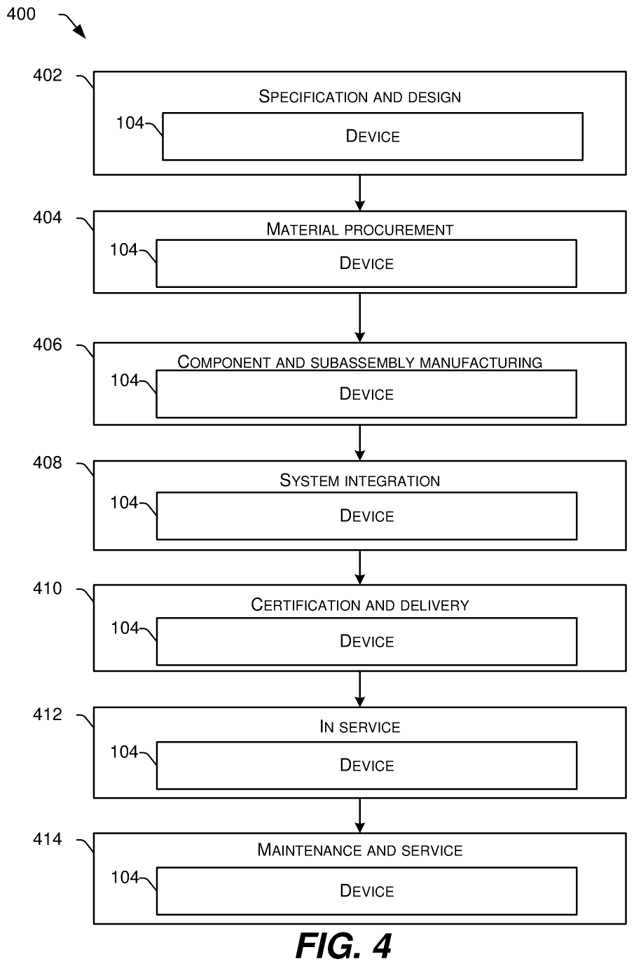

FIG. 4 is a flowchart illustrating an example 400 of a life cycle of an aircraft that includes the device 104 of FIG. 1. During pre-production, the exemplary method 400 includes, at block 402, specification and design of the aircraft. During specification and design of the aircraft, the method 400 may include specification and design of the device 104 and locations where the device 104 are to be placed. At block 404, the method 400 includes material procurement, which may include procuring materials for the device 104 or procuring pre-assembled device 104.

During production, the method 400 includes, at block 406, component and subassembly manufacturing and, at block 408, system integration of the aircraft. For example, the method 400 may include component and subassembly manufacturing of the device 104, system integration of the device 104 with the aircraft, or both. At block 410, the method 400 includes certification and delivery of the aircraft and, at block 412, placing the aircraft in service. Certification and delivery may include certification of the device 104 to place the device 104 in service. While in service by a customer, the aircraft may be scheduled for routine maintenance and service (which may also include modification, reconfiguration, refurbishment, and so on). At block 414, the method 400 includes performing maintenance and service on the aircraft, which may include performing maintenance and service on the device 104. For example, the maintenance and service can include replacing one or more computer components included in the device 104.

Each of the processes of the method 400 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

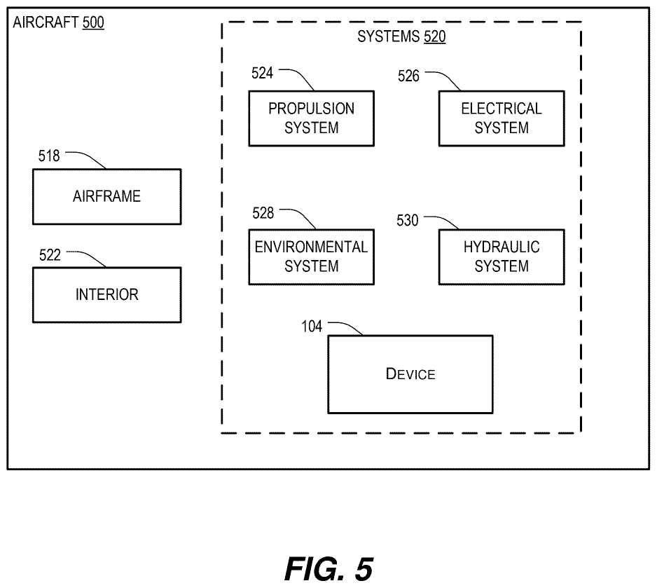

Aspects of the disclosure can be described in the context of an example of an aircraft 500 as shown in FIG. 5. In the example of FIG. 5, the aircraft 500 includes an airframe 518 with a plurality of systems 520 and an interior 522. Examples of the plurality of systems 520 include one or more of a propulsion system 524, an electrical system 526, an environmental system 528, a hydraulic system 530, and the device 104. Any number of other systems may be included. In the example of FIG. 5, the aircraft 500 includes the device 104 in accordance with one or more aspects of the disclosure as described in FIGS. 1-4. Portions of the device 104 are included in the airframe 518 and the interior 522.

FIG. 6 is a block diagram of a computing environment 600 including a computing device 610 configured to support aspects of computer-implemented methods and computer-executable program instructions (or code) according to the present disclosure. For example, the computing device 610, or portions thereof, is configured to execute instructions to initiate, perform, or control one or more operations described with reference to FIGS. 1-5.

The computing device 610 includes one or more processors 620. In some aspects, the processor(s) 620 includes the processor(s) 116, as described in FIG. 1. The processor(s) 620 are configured to communicate with system memory 630, one or more storage devices 640, one or more input/output interfaces 650, one or more communications interfaces 660, or any combination thereof. The system memory 630 includes volatile memory devices (e.g., random access memory (RAM) devices), nonvolatile memory devices (e.g., read-only memory (ROM) devices, programmable read-only memory, and flash memory), or both. The system memory 630 may include or correspond to the memory 106, as described in FIG. 1. The system memory 630 stores an operating system 632, which may include a basic input/output system for booting the computing device 610 as well as a full operating system to enable the computing device 610 to interact with users, other programs, and other devices. The system memory 630 stores system (program) data 636 and applications 634, such as the operational intent monitor 118, the control system 120, or a combination thereof.

The system memory 630 includes one or more operating systems 632 and/or one or more applications 634 (e.g., sets of instructions) executable by the processor(s) 620. As an example, the one or more applications 634 include instructions executable by the processor(s) 620 to initiate, control, or perform one or more operations described with reference to FIGS. 1-5, such receiving command and intent data related to a proposed operation of a device, determining an operational context based on sensor data and the proposed operation, performing a comparison based on the operational context and the command and intent data, generating an output signal based on the comparison, and controlling the proposed operation of the device based on the generated output signal.

In a particular implementation, the system memory 630 includes a non-transitory, computer-readable medium storing the instructions that, when executed by the processor(s) 620, cause the processor(s) 620 to initiate, perform, or control operations to aid in generating an output signal based on the comparison, and controlling the proposed operation of the device based on the generated output signal. The operations include receiving command and intent data related to a proposed operation of a device, determining an operational context based on sensor data and the proposed operation, performing a comparison based on the operational context and the command and intent data, generating an output signal based on the comparison, and controlling the proposed operation of the device based on the generated output signal.

The one or more storage devices 640 include nonvolatile storage devices, such as magnetic disks, optical disks, or flash memory devices. In a particular example, the storage devices 640 include both removable and non-removable memory devices. The storage devices 640 are configured to store an operating system, images of operating systems, applications (e.g., one or more of the applications 634), and program data (e.g., the program data 636). In a particular aspect, the system memory 630, the storage devices 640, or both, include tangible computer-readable media. In a particular aspect, one or more of the storage devices 640 are external to the computing device 610. In some implementations, the one or more storage devices 640 include or correspond to the memory 106, as described in FIG. 1.

The one or more input/output interfaces 650 enable the computing device 610 to communicate with one or more input/output devices 670 to facilitate user interaction. For example, the one or more input/output interfaces 650, an input interface, or both. For example, the input/output interface 650 is adapted to receive input from a user, to receive input from another computing device, or a combination thereof. In some implementations, the input/output interface 650 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 670 includes one or more user interface devices and displays, including some combination of buttons, keyboards, pointing devices, displays, speakers, microphones, touch screens, and other devices. Additionally, or alternatively, the one or more input/output interfaces 650 may include or correspond to the receiver 116, as described in FIG. 1.

The processor(s) 620 are configured to communicate with devices or controllers 680 via the one or more communications interfaces 660. For example, the one or more communications interfaces 660 can include a network interface. Additionally, or alternatively, the one or more communications interfaces 660 may include or correspond to the receiver 116, as described in FIG. 1. In some implementations, the devices or controllers 680 may include or correspond to the device 128, as described in FIG. 1.

In some implementations, a non-transitory, computer-readable medium stores instructions that, when executed by one or more processors, cause the one or more processors to initiate, perform, or control operations to perform part or all of the functionality described above. For example, the instructions may be executable to implement one or more of the operations or methods of FIGS. 1-5. In some implementations, part, or all of one or more of the operations or methods of FIGS. 1-5 may be implemented by one or more processors (e.g., one or more central processing units (CPUs), one or more graphics processing units (GPUs), one or more digital signal processors (DSPs)) executing instructions, by dedicated hardware circuitry, or any combination thereof.

Particular aspects of the disclosure are described below in sets of interrelated Examples:

According to Example 1, a method of operating an autonomous control system within a device includes receiving command and intent data related to a proposed operation of a device; determining an operational context based on sensor data and the proposed operation; performing a comparison based on the operational context and the command and intent data; generating an output signal based on the comparison; and controlling the proposed operation of the device based on the generated output signal.

Example 2 includes the method of Example 1, where the sensor data includes: audio data indicative of sound patterns in an environment associated with the device; radio frequency data indicative of communication patterns; visual data indicative of objects or persons in the environment; and atmospheric data indicative of environmental conditions.

Example 3 includes the method of Example 1 or Example 2, where the proposed operation includes a path planning operation for the device.

Example 4 includes the method of any of Examples 1 to 3, where the output signal includes an enable signal; and controlling the proposed operation of the device includes executing the proposed operation in response to the enable signal.

Example 5 includes the method of any of Examples 1 to 4, where the output signal includes a disable signal; and controlling the proposed operation of the device includes preventing execution of the proposed operation in response to the disable signal.

Example 6 includes the method of any of Examples 1 to 5, where receiving the proposed operation includes receiving the proposed operation from a user input interface or the autonomous control system.

Example 7 includes the method of any of Examples 1 to 6, where the proposed operation includes one or more of modifying operational constraints of the autonomous control system, evaluating potential outcomes based on the operational context, or implementing modified operational parameters to achieve an improved overall safety outcome.

Example 8 includes the method of any of Examples 1 to 7, further includes recording, in a memory as recorded data, the output signal, the operational context, and the command and intent data; and storing a timestamp and system state data of the autonomous control system associated with the recorded data.

Example 9 includes the method of any of Examples 1 to 8, where determining the operational context includes identifying a set of environmental conditions from the sensor data; determining relationships within the set of the environmental conditions, and comparing the relationships to operational requirements specified in the command and intent data.

Example 10 includes the method of any of Examples 1 to 9, further includes verifying an authority level associated with a source of the command and intent data; validating that the command and intent data conform to a predefined grammatical structure; and authenticating integrity of the command and intent data.

Example 11 includes the method of any of Examples 1 to 10, where the command and intent data includes a plurality of rule sets defining authorized operations for the autonomous control system, operational parameters specifying environmental conditions for each rule set, combinatorial logic defining valid rule set applications, and priority designations for resolving conflicts between rule sets.

Example 12 includes the method of any of Examples 1 to 11, further includes receiving updated sensor data during execution of the proposed operation; determining an updated operational context based on the updated sensor data; evaluating the proposed operation against the updated operational context; and modifying the proposed operation based on the updated operational context.

Example 13 includes the method of any of Examples 1 to 12, further includes receiving a second proposed operation from the autonomous control system; evaluating the second proposed operation against the operational context prior to execution; generating a second output signal; and providing the second output signal to the autonomous control system.

According to Example 14, a device includes one or more processors configured to receive command and intent data related to a proposed operation of the device; determine an operational context based on sensor data and the proposed operation; perform a comparison based on the operational context and the command and intent data; generate an output signal based on the comparison; and control the proposed operation of the device based on the generated output signal.

Example 15 includes the device of Example 14, where the output signal includes an enable signal, and the control of the proposed operation of the device includes execution of the proposed operation in response to the enable signal.

Example 16 includes the device of Example 14 or Example 15, where the output signal includes a disable signal, and the control of the proposed operation of the device includes prevention of an execution of the proposed operation in response to the disable signal.

Example 17 includes the device of any of Examples 14 to 16 and further includes one or more sensors configured to generate the sensor data, and where the sensor data is indicative of environmental conditions associated with the device.

Example 18 includes the device of any of Examples 14 to 17, where the one or more processors are further configured to verify authenticity of the command and intent data, validate that the command and intent data conform to a predefined grammatical structure, and determine operational authorization based on the verification and validation.

Example 19 includes the device of Example 18, where the predefined grammatical structure includes syntax rules for specifying operational constraints, semantic rules for defining relationships between constraints, and validation rules for evaluating constraint combinations.

According to Example 20, a non-transitory computer-readable medium includes instructions that, when executed by one or more processors, cause the one or more processors to receive command and intent data related to a proposed operation of a device; determine an operational context based on sensor data and the proposed operation; perform a comparison based on the operational context and the command and intent data; generate an output signal based on the comparison; and control the proposed operation of the device based on the generated output signal.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A method of operating an autonomous control system within a device, the method comprising:
receiving command and intent data related to a proposed operation of a device;
determining an operational context based on sensor data and the proposed operation;
performing a comparison based on the operational context and the command and intent data;
generating an output signal based on the comparison; and
controlling the proposed operation of the device based on the generated output signal.

2. The method of claim 1, wherein the sensor data comprises:
audio data indicative of sound patterns in an environment associated with the device;
radio frequency data indicative of communication patterns;
visual data indicative of objects or persons in the environment; and
atmospheric data indicative of environmental conditions.

3. The method of claim 1, wherein the proposed operation comprises a path planning operation for the device.

4. The method of claim 1, wherein:
the output signal comprises an enable signal; and
controlling the proposed operation of the device comprises executing the proposed operation in response to the enable signal.

5. The method of claim 1, wherein:
the output signal comprises a disable signal; and
controlling the proposed operation of the device comprises preventing execution of the proposed operation in response to the disable signal.

6. The method of claim 1, wherein receiving the proposed operation comprises receiving the proposed operation from a user input interface or the autonomous control system.

7. The method of claim 1, wherein the proposed operation comprises one or more of:
modifying operational constraints of the autonomous control system,
evaluating potential outcomes based on the operational context, or
implementing modified operational parameters to achieve an improved overall safety outcome.

8. The method of claim 1, further comprising:
recording, in a memory as recorded data, the output signal, the operational context, and the command and intent data; and
storing a timestamp and system state data of the autonomous control system associated with the recorded data.

9. The method of claim 1, wherein determining the operational context comprises:
identifying a set of environmental conditions from the sensor data;
determining relationships within the set of the environmental conditions; and
comparing the relationships to operational requirements specified in the command and intent data.

10. The method of claim 1, further comprising:
verifying an authority level associated with a source of the command and intent data;
validating that the command and intent data conform to a predefined grammatical structure; and
authenticating integrity of the command and intent data.

11. The method of claim 1, wherein the command and intent data comprises:
a plurality of rule sets defining authorized operations for the autonomous control system;
operational parameters specifying environmental conditions for each rule set;
combinatorial logic defining valid rule set applications; and
priority designations for resolving conflicts between rule sets.

12. The method of claim 1, further comprising:
receiving updated sensor data during execution of the proposed operation;
determining an updated operational context based on the updated sensor data;
evaluating the proposed operation against the updated operational context; and
modifying the proposed operation based on the updated operational context.

13. The method of claim 1, further comprising:
receiving a second proposed operation from the autonomous control system;
evaluating the second proposed operation against the operational context prior to execution;
generating a second output signal; and
providing the second output signal to the autonomous control system.

14. A device comprising:
one or more processors configured to:
receive command and intent data related to a proposed operation of the device;
determine an operational context based on sensor data and the proposed operation;
perform a comparison based on the operational context and the command and intent data;
generate an output signal based on the comparison; and
control the proposed operation of the device based on the generated output signal.

15. The device of claim 14, wherein:
the output signal comprises an enable signal; and
the control of the proposed operation of the device comprises execution of the proposed operation in response to the enable signal.

16. The device of claim 14, wherein:
the output signal comprises a disable signal; and
the control of the proposed operation of the device comprises prevention of an execution of the proposed operation in response to the disable signal.

17. The device of claim 14, further comprising one or more sensors configured to generate the sensor data, wherein the sensor data is indicative of environmental conditions associated with the device.

18. The device of claim 14, wherein the one or more processors are further configured to:
verify authenticity of the command and intent data;
validate that the command and intent data conform to a predefined grammatical structure; and
determine operational authorization based on the verification and validation.

19. The device of claim 18, wherein the predefined grammatical structure comprises:
syntax rules for specifying operational constraints;
semantic rules for defining relationships between constraints; and
validation rules for evaluating constraint combinations.

20. A non-transitory computer-readable medium comprising instructions that, when executed by one or more processors, cause the one or more processors to:
receive command and intent data related to a proposed operation of a device;
determine an operational context based on sensor data and the proposed operation;
perform a comparison based on the operational context and the command and intent data;
generate an output signal based on the comparison; and
control the proposed operation of the device based on the generated output signal.
